(19) United States
(12) Patent Application Publication
(10) Pub. No.: US 2009/0091619 A1
(43) Pub. Date: Apr. 9, 2009

(54) HID & IR spotlight with integrated camera system

(76) Inventors: William E. Rosemeyer, Wexford, PA (US); James M. Helms, Mars, PA (US)

Correspondence Address: KAREN TANG-WAI SODINI, 216 horseshoe drive, MARS, PA, 16046, US

(21) Appl. No.: 12/283,335

(22) Filed: Sep. 11, 2008

Related U.S. Application Data
(60) Provisional application No. 60/998,158, filed on Oct. 9, 2007.

(51) Int. Cl. H04N 7/18

(52) U.S. Cl. 348/148; 348/E07.085

(57) ABSTRACT

A spotlight, including hardware for mounting to a vehicle (especially a police or security vehicle), including an HID lamp or other visible light illuminator, an infrared illuminator, and an integrated camera system including a video capture device for providing a video feed formed using the visible or infrared light, and a remote terminal including a viewer for viewing the video feed.

### CROSS REFERENCE TO RELATED APPLICATIONS

Reference is made to and priority claimed from U.S. provisional application Ser. No. 60/998,158 filed on Oct. 9, 2007.

### FIELD OF THE INVENTION

The present invention pertains to the field of accessories for motorized vehicles. More particularly, the present invention pertains to the field of vehicular mounted high intensity discharge (HID) & infrared (IR) illumination sources having media capturing devices.

### BACKGROUND OF THE INVENTION

Many civilian police vehicles and many military vehicles (e.g. the HMMWV/high mobility multipurpose wheeled vehicle) have a spotlight mounted on the vehicle, so that the spotlight can be operated by the driver while inside the vehicle. Such a spotlight today often may use an HID (high intensity discharge) lamp.

An HID lamp consumes less power than an incandescent lamp and has a luminous intensity even greater than a halogen lamp, approximately 200,000 cd. The color temperature of an HID light is in the range of 5000 K, similar to daylight. The average lifespan of an HID bulb is 2000 hours, roughly 5 times longer than a standard incandescent lamp. HID lamps work by producing an electric arc through a gas (typically xenon for automotive applications). A small lighting ballast is required to produce the arc when used with automotive voltages. (A lighting ballast is a piece of equipment required to control the starting and operating voltages of electrical gas discharge lights, such as HID lamps, and also fluorescent and neon lights. The term lighting ballast for a light can refer to any component of a circuit intended to limit the flow of current through the light, from a single resistor to more complex devices.)

In many situations faced by police and security forces, it would be advantageous to monitor activity covertly, and it would also be advantageous to record activity being monitored, either covertly or otherwise.

### SUMMARY

The invention provides a spotlight system that includes a normal spotlight function, but also allows both covert surveillance and recording activity being surveilled covertly or otherwise, for contemporaneous viewing or later playback.

### BRIEF DESCRIPTION OF THE DRAWINGS

The features and advantages of the invention will become apparent from a consideration of the subsequent detailed description presented in connection with accompanying drawings, in which:

FIG. 1 is a perspective drawing of a spotlight according to the invention, for mounting onto a vehicle.

FIG. 2 is a sectional view of the spotlight showing the internal components.

FIG. 3 is an exploded view of the spotlight of FIG. 1.

FIG. 4 is a block diagram of a system according to the invention including the spotlight of FIG. 1 and the remote control system.

### DRAWINGS LIST OF REFERENCE NUMERALS

The following is a list of reference labels used in the drawings to label components of different embodiments of the invention, and the names of the indicated components.
11 spotlight
11b IR (infrared) illuminator
11c video capture device (camera)
11d mounting attachment
11e faceplate
11f HID ballast
11g reflector
11h spotlight housing
11i spotlight frame interior space
11j spotlight front face
12 remote control system
12a remote terminal with video display device, camera controller, and video recorder
12c illumination controller
14 HID and IR spotlight with integrated camera system
15 first gasket
16 second gasket
18 reflector cover
20 HID (high intensity discharge) lamp
20a bulb portion of the HID lamp
20b non-bulb portion of the HID lamp

### DETAILED DESCRIPTION

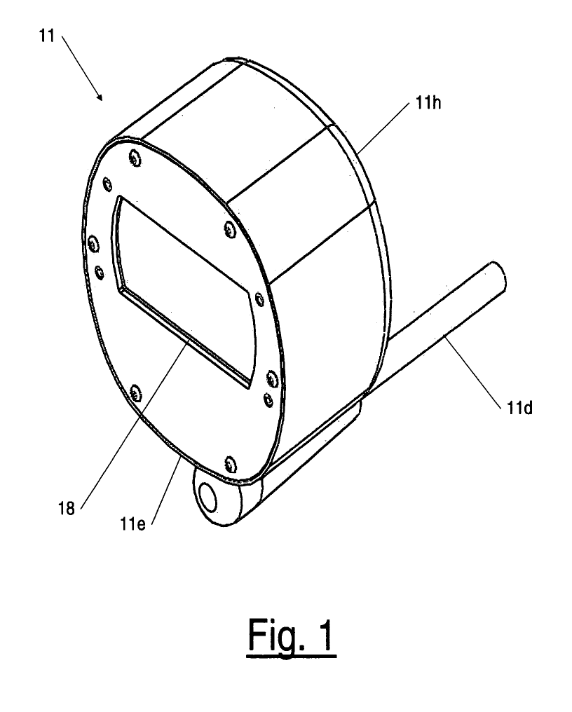

As can be seen from FIGS. 1-4, an embodiment of the invention provides a spotlight 11, having a HID (high intensity discharge) lamp 20, an IR (infrared) illuminator 11b, and an integrated camera system 14 comprising a video capture device (camera) 11c housed inside the spotlight 11 capable of providing a video feed to a remote terminal 12a for live viewing or recording for later viewing. The video capture device is typically an analog camera (e.g. a so-called lipstick camera of the sort typically used in surveillance), and the video feed is typically converted to digital format by a DVR (digital video recorder) used to record the video for later viewing. The transmission can be wireless or via wireline. The spotlight is typically mounted to a vehicle on e.g. the so-called A column of the vehicle on the driver side, and interfaces to a pointing mechanism that allows the driver of the vehicle to point the spotlight from within the cabin. The video capture device is typically configured to transmit the video feed to a terminal inside the cabin of the vehicle. The terminal would typically include a video display device for viewing the video feed live or after first being recorded by the DVR (viewer).

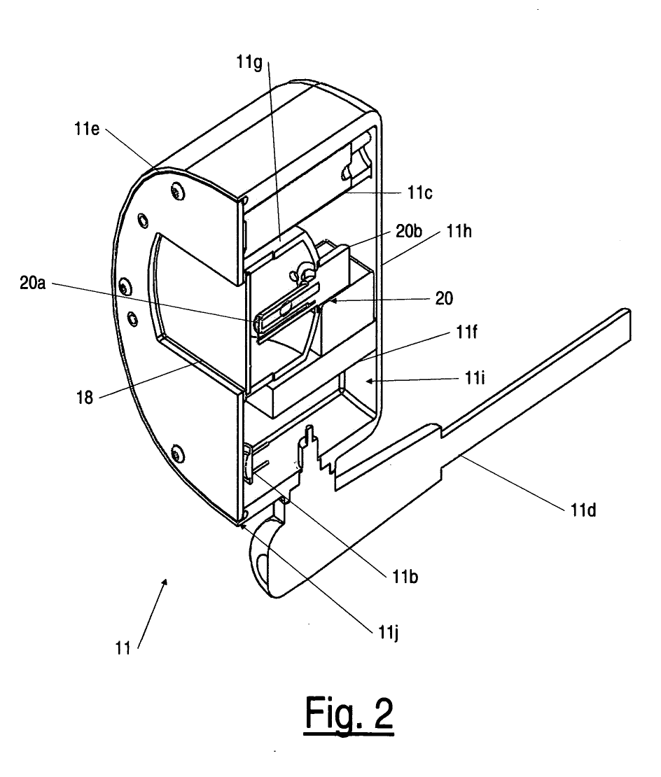

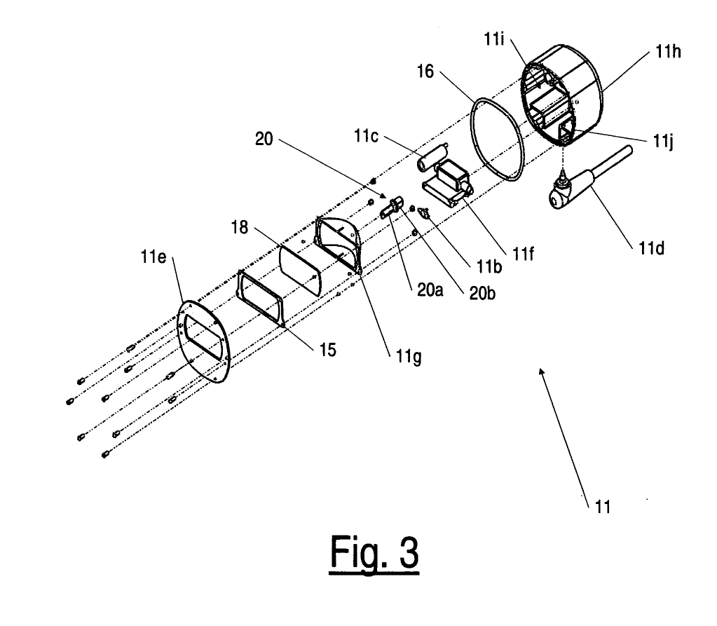

As shown more particularly in FIGS. 2 and 3, one embodiment of the invention provides a spotlight 11 having a housing 11h with an interior space 11i and a front face 11j, and a faceplate 11e. Mounted inside the interior space 11i are the video capture device 11c, the IR illuminator 11b, and a HID ballast 11f used to provide a first voltage for turning on the HID lamp 20, and a second, lower voltage for continued operation of the HID lamp, both using a supply voltage of some constant voltage level typically in the range of from 9 volts to 34 volts. The HID lamp 20 is mounted with a bulb portion 20a inside a reflective parabolic surface or reflector 11g, and the remaining non-bulb portion 20b is electrically connected to the HID ballast 11f inside the interior space 11i. The reflector 11g creates a focused beam of visible light in the direction the spotlight 11 is oriented when the HID lamp 20 is turned on. A reflector cover 18 is placed in front of and over the reflector 11g followed by a first gasket 15 that is sandwiched between the faceplate 11e and the cover 18. Sandwiched between the faceplate 11e and the spotlight housing front face 11j is a second gasket 16 that ensures a secure, weatherproof connection between the faceplate 11e and the front face 11j of the spotlight housing 11h.

In some embodiments of the invention, the faceplate 11e is made of a transparent material such as glass, plastic or other suitable materials that allow light to pass through.

The HID ballast 11f is electrically connected to the HID lamp 20, and provides the lamp 20 proper voltage and current during starting (turning on) and continued operation (the voltage and current for starting being very different than what is provided during continued operation). The ballast 11f may be of any suitable type, including electric and/or electronic, and typically is itself provided with power from a power supply (which could be a battery) of a sort able to provide voltage in the range of from 9 volts to 34 volts, and able to provide current of typically at least as much as 5 amps for a few seconds (for starting), and about 2 amps for continued operation.

In one embodiment of the invention, the HID lamp 20 uses xenon gas to produce light when a current is passed through it.

Also shown in FIGS. 1 and 2 is a mounting attachment 11d for mounting the spotlight 11 onto a vehicle. Advantageously, the mounting attachment 11d is the same as what is currently used to mount spotlights on vehicles such as a Crown Victoria adapted for use as a police vehicle, and also where spotlights are mounted through a so-called A-column (on either the driver side or both the driver and the passenger side), sometimes called the Unity post, provided by Unity Manufacturing Company of Chicago, Ill. The mounting attachment 11d generally is either a swivel or pivot type mount.

The IR illuminator 11b typically includes nine IR LEDs (light emitting diodes) connected in series. In a typical embodiment, the IR LEDs provide illumination at 880 nanometers (nm), to match the light spectrum of night vision equipment typically used by vehicle operators. An exemplary IR LED is the OD-669 high-powered gallium aluminum arsenide (GaAlAs) IR LED illuminator provided by Opto Diode Corporation, of Newbury Park, Calif. The IR illuminator 11b enables driving at normal operating speed when using night vision devices.

Elements of the spotlight housing 11h may be fabricated from any suitable material, including steel, aluminum, plastic, or composites.

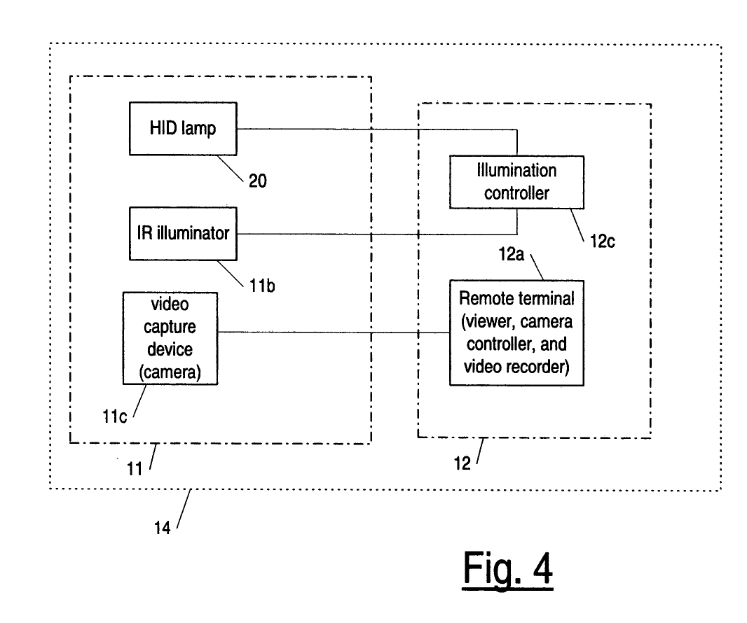

Referring now in particular to FIG. 4, the remote terminal 12a includes a camera controller (not separately shown), for operating the video capture device 11c from within the vehicle cabin, i.e. for at least turning on and off the video capture device. The camera controller may be coupled to the video capture device 11c via wireline or even wirelessly, via a transmitter (not shown), using radiofrequency communication.

As mentioned above, the remote terminal 12a is located in the vehicle cabin, and the video feed is provided to the remote terminal wirelessly, using radiofrequency communication enabled by a transceiver (not shown, but such as a transceiver known in the art and commonly used on e.g. surveillance cameras that provide video wirelessly to a remote control center), or via wireline, and may be radiofrequency or lower frequency in case of a wireline transmission. (In case of wireless transmission of the video feed and also the on and off signaling for the video capture device, a single transmitter would be used for wireless coupling of the video capture device to the remote terminal.)

The invention also provides an illumination controller 12c located in the vehicle cabin, i.e. an on/off switching system, for turning on and off the IR illuminator 11b and for turning on and off the HID lamp 20. Advantageously, the illumination controller 12c includes a different control for the IR illuminator 11b and for the HID lamp 20, and the control for the HID lamp 20 is the same as is currently already available on vehicles that have a spotlight according to the prior art (a switch accessible to the driver). In other words, when the invention is provided for a vehicle having a HID spotlight according to the prior art, the invention is advantageously provided so as to use the same switching/control mechanism for the HID lamp as is already present in a vehicle. The on and off signaling for the illuminators can be via a wireline, or can be wireless, using a radiofrequency transmitter (not shown), and can even use the same radiofrequency transmitter as is used in case of wireless coupling of the remote terminal to the video capture device.

Although the invention has been described here as including an HID light 20 (and ballast for same) as a visible light illuminator, the invention also encompasses a visible light illuminator utilizing high-powered visible light LEDs (providing e.g. white light, using e.g. phosphor conversion), which do not require a ballast. A typical white light LED suitable for the invention is an OSRAM LE W E3B, available from OSRAM Opto Semiconductors, Inc., of Santa Clara, Calif. The invention would typically utilize two or more such LEDs in place of a single HID bulb (possibly as many as five LEDs).

For covert operation, it is anticipated that the driver would use night vision goggles to operate the vehicle, while another crew member would operate the spotlight without using NVGs (not at the same time of course), either one relying on the video display (the remote viewer and digital camera controller) to determine where to direct the spotlight.

The invention is of use, e.g., as an accessory for utility vehicles, including civil or military police vehicles, such as the Ford Crown Victoria, and tactical military vehicles such as the HMMWV (high mobility multipurpose wheeled vehicle). As is clear from the description, though, the invention is clearly of use in other than such vehicles, and in particular is of use in case of military or civilian vehicles intended to be driven or utilized in low-light conditions with the aid of night-vision devices.

It is to be understood that the arrangements shown and described above and in the attachments are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. An apparatus for providing spotlight function and covert surveillance and recording activity, comprising:
a spotlight (11) having a housing (11h) including a mounting attachment (11d) for mounting to a vehicle;
at least one infrared illuminator (11b) mounted inside the spotlight housing (11h);
at least one visible light illuminator (20) attached to the housing;
a video capture device (11c) mounted inside the spotlight housing (11h), responsive to visible or infrared light, for providing a video feed based on the visible or infrared light;
a terminal (12a) operatively coupled to the video capture device (11c), for turning on and off the video capture device (11c) and for receiving and displaying the video feed; and
an illumination controller (12c) operatively coupled to the visible light illuminator (20) and to the infrared illuminator (11b), for turning on and off the visible light illuminator (20) and for turning on and off the infrared illuminator (11b).

2. The apparatus of claim 1, wherein the visible light illuminator (20) comprises a high intensity discharge light and accompanying ballast.

3. The apparatus of claim 1, wherein the visible light illuminator (20) comprises one or more light emitting diodes providing visible light.

4. The apparatus of claim 1, wherein the illumination controller (12c) is operatively coupled to the illuminators (11b 20) via a wireline, for turning on and off the illuminators (11b 20).

5. The apparatus of claim 1, wherein the illumination controller (12c) is wirelessly operatively coupled to the illuminators (11b 20) via a transmitter, for turning on and off the illuminators (11b 20).

6. The apparatus of claim 1, wherein the terminal (12a) includes a controller for turning on and off the video capture device (11c), and includes a video display device for displaying the video feed, and includes a recorder for recording the video feed, and wherein the terminal (12a) is wirelessly coupled to the video capture device (11c) via a transmitter.

7. The apparatus of claim 1, wherein the terminal (12a) includes a video display device for displaying the video feed, and the video display device is wirelessly coupled to the video capture device (11c) via a transmitter.

8. The apparatus of claim 1, wherein the terminal (12a) includes a controller for turning on and off the video capture device (11c) and the controller is operatively coupled to the video capture device (11c) via a wireline, for turning on and off the video capture device (11c).
